(19) United States
(12) Patent Application Publication
(10) Pub. No.: US 2015/0038636 A1
(43) Pub. Date: Feb. 5, 2015

(54) COMPOSITION, ELASTOMER BODY AND COUPLING

(71) Applicant: GKN STROMAG AKTIENGESELLSCHAFT, Unna (DE)

(72) Inventors: Thomas Kamps, Holzwickede (DE); Volker Wegener, Unna (DE); Irina Gutjar, Werl (DE); Axel Blaurock, Werne (DE)

(21) Appl. No.: 14/384,970

(22) PCT Filed: Mar. 8, 2013
(86) PCT No.: PCT/EP2013/054675

§ 371 Date: Sep. 12, 2014

(30) Foreign Application Priority Data
Mar. 15, 2012 (DE) 10 2012 204 125.7

(51) Int. Cl. C08L 9/00; C08L 7/00

(52) U.S. Cl. CPC C08L 9/00; C08L 7/00; F16D 3/50
USPC 524/526; 525/236; 464/903

(57) ABSTRACT

The invention relates to a composition, especially for an elastomer body of an elastic coupling, comprising the following components:—polyisoprene rubber having a proportion of 20 to 30% by weight,—butadiene rubber having a proportion of 20 to 30% by weight, based in each case on the total weight of the composition. The invention further relates to the use of the composition for production of an elastomer body, especially for an elastic coupling, preferably elastic shaft coupling. The invention additionally relates to an elastomer body, especially for an elastic coupling, which comprises the composition. The invention also relates to a coupling comprising the composition or the elastomer body.

The invention relates to a composition, in particular for an elastomer body of an elastic coupling, to a use of the composition, to an elastomer body, and also to a coupling.

Elastic shaft couplings for transmitting torque are known from mechanical engineering and plant construction. These shaft couplings always comprise one or more elastomer bodies which, during operation of the coupling, are subjected to torsional shear loads.

Material of which the elastomer bodies are composed here can be synthetic rubber, for example butadiene rubber or silicone.

Although in principle butadiene rubber can be used successfully for dynamic applications, processing of butadiene rubber is difficult because it does not easily form a roll-milled sheet.

Silicone has the disadvantage of low strength values, in particular tear strength values, and this is disadvantageous for dynamic loads. Silicone couplings accordingly feature short lifetime. They are moreover difficult to produce and, most importantly, are rendered expensive by high materials costs.

Silicone couplings are in particular intended for low-temperature applications. However, a disadvantage here is that when an engine or motor has to be started at low temperatures and has not retained heat from previous operation any silicone couplings require preheating.

The present invention is therefore based on the object of providing a composition, a use, an elastomer body, and a coupling, in particular a shaft coupling of the type mentioned in the introduction, where these avoid inadequacies known from the prior art, in particular the disadvantages mentioned in the introduction.

Said object is achieved via a composition with the features of independent claim 1, via a use with the features of claim 5, via an elastomer body with the features of claim 6, and via a coupling with the features of claim 7. Preferred embodiments are provided by dependent claims 2 to 4 and 8. The wording of all of the claims is hereby incorporated by way of reference into the content of the present description.

The composition of the invention is a composition in particular for an elastomer body of an elastic coupling, comprising polyisoprene rubber and butadiene rubber (or polybutadiene rubber).

The composition preferably features from 20 to 30% by weight content of polyisoprene rubber and from 20 to 30% by weight content of butadiene rubber, based in each case on the total weight of the composition.

Surprisingly, it has been found that the composition proposed in the invention can be used for the production of elastic couplings, especially for advantageously influencing torsional vibrations in drive systems.

In particular, it was found here that, even at low temperatures, in particular at a temperature markedly below −50° C., for example at a temperature of about −70° C., there is only an insignificant increase in the torsion spring stiffness of couplings of this type. Damping of vibrations in drive trains subject to dynamic stresses or dynamic loads is thus ensured, and damage to an installation or to an engine or motor is avoided.

When elastic couplings with the composition proposed in the invention are used it is moreover possible to achieve low-temperature starting of engines or motors that have not retained heat from previous operation, without any requirement to preheat the coupling.

In other words, the composition of the invention allows the production of elastic couplings which can also be operated in the low-temperature range.

Since the invention renders preheating of couplings superfluous in low-temperature applications, it is also possible to save energy costs. Considerable cost savings are thus possible, depending on the number and size of the installations, engines, or motors to be operated.

Another advantage of the composition proposed in the invention consists in the low materials costs for the rubber components thereof. In comparison with the use of silicone as material it is possible to save up to 70% of materials costs.

For the purposes of the present invention, the expression “polyisoprene rubber” is intended to mean a polyisoprene (poly-2-methylbuta-1,3-diene) with rubber elastic properties.

For the purposes of the present invention, the expression “butadiene rubber” or “polybutadiene rubber” is intended to mean a polybutadiene with rubber elastic properties.

The composition preferably comprises the polyisoprene rubber and the butadiene rubber as mixture, in particular blend or compounded material.

In one preferred embodiment, the polyisoprene rubber is a cis-1,4-polyisoprene rubber.

In one particularly preferred embodiment, the polyisoprene rubber is natural rubber. Natural rubber occurs in the latex from the laticifers of numerous dicotyledons. Natural rubber is obtained almost exclusively from the latex that exudes when incisions are made in the secondary bark of the trunks of rubber trees or para rubber trees (Hevea brasiliensis, family Euphorbiaceae). In chemical terms, natural rubber is a naturally occurring cis-1,4-polyisoprene.

In an alternative embodiment, the polyisoprene rubber can be an industrial or synthetic polyisoprene rubber (isoprene rubber or synthetic cis-1,4-polyisoprene).

In particular, the polyisoprene rubber can take the form of trans-1,4-polyisoprene rubber. The trans-1,4-polyisoprene rubber can be of synthetic or natural origin. By way of example, the polyisoprene rubber can take the form of gutta-percha, i.e. naturally occurring trans-1,4-polyisoprene.

As already mentioned, the content of the polyisoprene rubber is preferably from 20 to 30% by weight, based on the total weight of the composition. The advantages described above in connection with the invention are particularly evident when the polyisoprene rubber contents provided in this embodiment are used.

The butadiene rubber can in principle be selected from the group consisting of cis-1,4-polybutadiene, trans-1,4-polybutadiene, 1,2-polybutadiene, and mixtures, in particular blends, thereof. The 1,2-polybutadiene can moreover be selected from the group consisting of isotactic 1,2-polybutadiene, syndiotactic 1,2-polybutadiene, and combinations, in particular blends, thereof.

In the invention it is particularly preferable that the butadiene rubber is cis-1,4-polybutadiene rubber.

As also already mentioned, the content of the butadiene rubber is preferably from 20 to 30% by weight, based on the total weight of the composition, The advantages explained in the introduction in connection with the invention are particularly evident when the butadiene rubber contents provided in this embodiment are used.

In another embodiment, the composition can comprise a plasticizer, the content of which is in particular from 0 to 10% by weight, preferably from 1 to 10% by weight, based on the total weight of the composition.

Suitable plasticizers can by way of example be selected from the group consisting of mineral oils, ether, thioether, ester, and mixtures thereof.

The composition can moreover comprise an aging inhibitor, the content of which is in particular <5% by weight, based on the total weight of the composition. The content of the aging inhibitor can preferably be >1% by weight and <5% by weight.

Suitable aging inhibitors can be selected from the group consisting of antioxidants, heat stabilizers, antiozonants, light stabilizers, fatigue inhibitors, hydrolysis stabilizers, and mixtures thereof.

The aging inhibitors can by way of example be aromatic amines such as diamines, in particular N-isopropyl-N′-phenyl-p-phenylenediamine, quinolines, phenols, phosphites, waxes, or the like.

In another embodiment, the composition also comprises a crosslinking agent or vulcanizing agent, the content of which is in particular <5% by weight, based on the total weight of the composition. The content of the crosslinking agent or vulcanizing agent can preferably be >1% by weight and <5% by weight.

Suitable crosslinking agents or vulcanizing agents can be selected from the group consisting of elemental sulfur, sulfur compounds, and sulfur-donor compounds (for example disulfur dichloride), peroxides, metal oxides, and mixtures thereof. Alternatively it is also possible to generate crosslinking or vulcanization by using high-energy radiation.

It is also possible in the invention that, in order to increase crosslinking rate or vulcanization rate, the composition also comprises a crosslinking accelerator or vulcanization accelerator.

The crosslinking accelerator or vulcanization accelerator can be selected from the group consisting of sulfur, sulfenamides, xanthogenates, dithiocarbamates, tetramethylthiuram disulfide, thiurams, thiazoles, in particular benzothiazoles, mercaptobenzothiazole, guanidines, thiourea derivatives, amine derivatives, and mixtures thereof.

In order to assist the action of crosslinking accelerators or vulcanization accelerators, it can furthermore be provided that the composition additionally comprises auxiliaries, in particular activators.

Suitable auxiliaries or activators can be selected from the group consisting of zinc oxide, antimony sulfide, fatty acids such as, for example, stearic acid, and mixtures thereof.

In another embodiment, the composition also comprises a metal oxide, in particular zinc oxide. The composition can comprise <5% by weight content of the metal oxide, preferably >1% by weight and <5% by weight, based on the total weight of the composition.

In another embodiment, the composition also comprises a filler, the content of which is in particular from 5% by weight to 55% by weight, in particular from 35% by weight to 55% by weight, based on the total weight of the composition.

The composition can in particular comprise an active filler and/or inactive filler. It can be preferable in the invention that the composition comprises a mixture or a combination of an active filler and an inactive filler, in particular where the ratio by weight of active filler to inactive filler is from 9:1 to 1:9. While the addition of an active filler affects the low-temperature flexibility of polyisoprene rubber and/or butadiene rubber, the low-temperature flexibility of these polymers is not affected when an inactive filler is added. Examples of an active filler are the substances carbon black and silicas mentioned below, while the silicates mentioned below are examples of an inactive filler. The content of the active filler and/or inactive filler can respectively be from 5% by weight to 50% by weight, based on the total weight of the composition.

The filler can be selected from the group consisting of carbon black, silica gel, silicas, silicates such as kaolin, chalk, talc, and mixtures thereof.

The composition can also comprise pigments such as organic dyes, lithopones, titanium dioxide, iron oxides, zinc oxide, chromium compounds, cadmium compounds, or the like.

In one particularly preferred embodiment, the composition comprises, based on 100% by weight:
from 20 to 30% by weight of polyisoprene rubber, preferably natural rubber,
from 20 to 30% by weight of butadiene rubber,
from 35 to 55% by weight of filler,
from 0 to 10% by weight of plasticizer,
<5% by weight of aging inhibitor, and
<5% by weight of crosslinking agent.

In another embodiment, the composition of the invention comprises no adduct compounds, in particular no dispersant adduct. In particular, the composition comprises no homogeneous dispersant adduct made of an adsorptive carrier substance, for example a zeolite and/or phyllosilicate, and of an adsorbed surface-active substance, for example a surfactant and/or emulsifier.

In suitable embodiments, the composition can consist of one of the combinations of components or of materials described in the preceding embodiments. In other words, it is possible in the invention that the composition consists of the polyisoprene rubber and of the butadiene rubber, and also optionally of other components—as in particular described in the embodiments above.

In a second aspect, the invention provides the use of the composition of the invention for the production of an elastomer body, in particular for a coupling, preferably shaft coupling, more preferably shaft coupling that is subject to torsional shear load. The coupling itself is preferably an elastic, in particular highly elastic, coupling. In relation to other features and advantages of the composition, of the elastomer body, and/or of the coupling, reference is made to the entirety of the description above and hereinafter.

In a third aspect, the invention provides an elastomer body, in particular for a coupling, preferably shaft coupling, more preferably shaft coupling subject to torsional shear load, where the elastomer body comprises the composition of the invention or optionally consists thereof. In relation to other features and advantages of the elastomer body, of the coupling, and/or of the composition, reference is likewise made to the entirety of the description above and hereinafter.

In a fourth aspect, the invention provides a coupling which comprises the composition of the invention or the elastomer body of the invention.

The coupling is preferably an elastic, in particular highly elastic, coupling.

In another embodiment, the coupling has been designed as shaft coupling, in particular shaft coupling subject to torsional shear load.

The coupling is preferably a plug-in coupling.

The coupling can moreover be provided for use in torque ranges from 160 to 80000 Nm, in particular from 160 to 40000 Nm.

The coupling can in particular be provided for construction of electrical assemblies, for generator installations, for drives, in particular vehicle propulsion systems, railroading propulsion systems, and/or boat propulsion systems, construction of compressors, the construction-site-machinery industry, and mechanical engineering, in particular the construction of engines or motors and shipbuilding.

It is preferable that the coupling is used for internal combustion engines, in particular diesel engines.

It is preferable that the elastomer body has been bonded coherently by means of vulcanization to at least one adjacent coupling component.

In order to avoid unnecessary repetition, in respect of other features and advantages of the coupling described for the purposes of the fourth aspect, in particular of the composition and/or of the elastomer body, reference is made to the entirety of the description above.

The invention further provides a composition, in particular for an elastomer body, preferably for an elastomer body of a coupling, preferably of an elastic coupling. The composition comprises an isoprene-containing polymer, preferably an isoprene-containing rubber, and a butadiene-containing, in particular 1,3-butadiene-containing, polymer, preferably a butadiene-containing, in particular 1,3-butadiene-containing, rubber.

For the purposes of the invention, the expression isoprene-containing polymer and, respectively, rubber is intended to mean a polymer comprising isoprene as monomer unit, or a rubber comprising isoprene as monomer unit.

For the purposes of the invention, the expression butadiene-containing, in particular 1,3-butadiene-containing, polymer and, respectively, rubber is intended to mean a polymer comprising butadiene, in particular 1,3-butadiene, as monomer unit, or a rubber comprising butadiene, in particular 1,3-butadiene, as monomer unit.

The content of the isoprene-containing polymer, preferably of the isoprene-containing rubber, is preferably from 20 to 30% by weight, based on the total weight of the composition.

The content of the butadiene-containing, in particular 1,3-butadiene-containing, polymer, preferably of the butadiene-containing, in particular 1,3-butadiene-containing, rubber, is preferably from 20 to 30% by weight, based on the total weight of the composition.

In relation to other features and advantages, in particular in respect of additional additives such as, for example, plasticizers, aging inhibitors, crosslinking agents, crosslinking accelerators, and the like, and also possible uses and applications, reference is made to the entirety of the description above and hereinafter.

Finally, the invention provides a composition, in particular for an elastomer body, preferably for an elastomer body of a coupling, preferably of an elastic coupling. The composition comprises a copolymer composed at least of isoprene (2-methylbuta-1,3-diene) and of butadiene, in particular 1,3-butadiene. It is preferable that the copolymer is composed of isoprene and butadiene. In relation to other features and advantages, in particular in respect of additional additives such as plasticizers, aging inhibitors, crosslinking agents, cross-linking accelerators, and the like, and also possible uses and applications, reference is likewise made to the entirety of the description above and hereinafter.

Other features and advantages of the invention are apparent from the descriptions provided below of the figures, from the associated figures, and from the claims.

The figures are diagrams of the following:

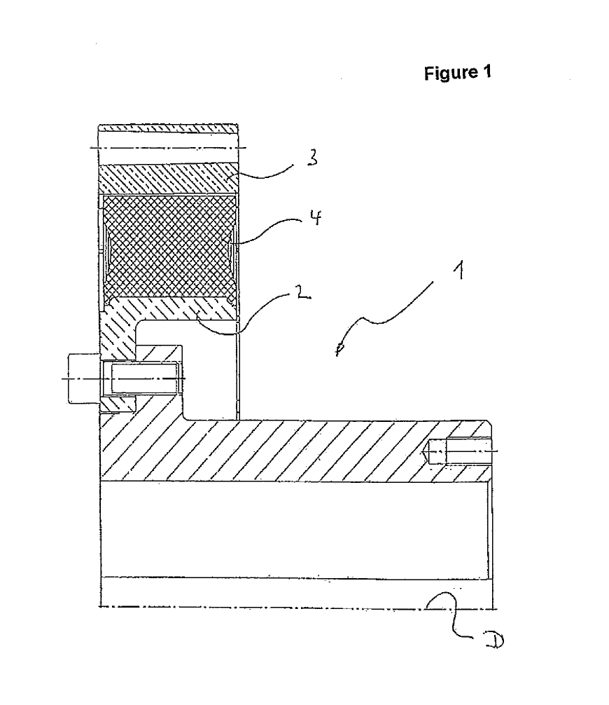

FIG. 1: an embodiment of a shaft coupling of the invention in a sectional view of an upper half of the shaft coupling, and

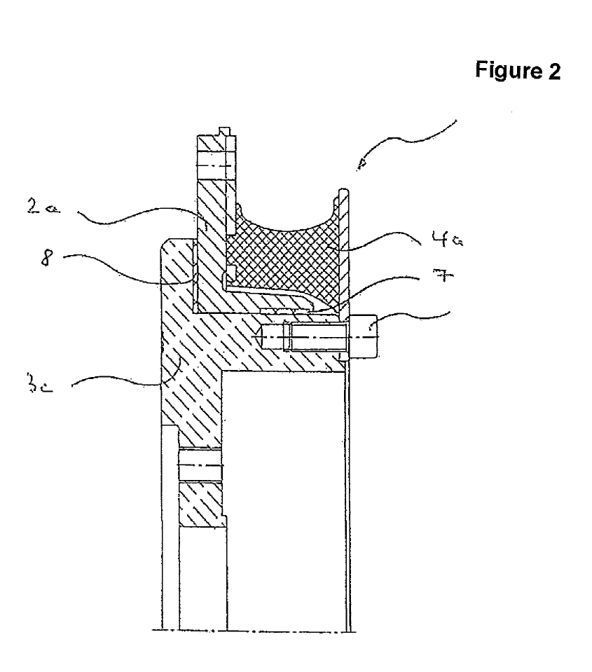

FIG. 2: an embodiment of a cardan shaft coupling of the invention in a sectional view.

FIG. 1 is a diagram of a highly elastic shaft coupling in the form of a disk coupling, intended in particular for internal combustion engines and designed with rotational symmetry around an axis D of rotation of the coupling. The shaft coupling is preferably used in torque ranges from 160 to 80000 Nm. The shaft coupling 1 serves for torque transmission from a first side of the coupling to a second side of the coupling in the field of drive technology.

The shaft coupling 1 has a radially inner coupling hub 2 on the first side of the coupling. At a radial distance from the coupling hub 2 there is an annular flange 3 provided on the second side of the coupling. The coupling hub 2 and the annular flange 3 are usually made of metal, for example of steel. Connection between the coupling hub 2 and the annular flange 3 is provided by an annular elastomer body 4 which extends radially between the coupling hub 2 and the coupling flange 3, coaxially in relation to the axis D of rotation.

The inner side of the elastomer body 4 has been vulcanized onto an external curved surface of the coupling hub 2 and is provided, in the region of its external periphery, with radially outward protruding insertable profile areas which are distributed over the entire external periphery and which are assigned complementary inner profile areas on the internal periphery of the annular flange 3. The insertable profile areas in connection with the inner profile areas are to achieve a positive locking torque transmission between the elastomer body 4 and the annular flange 3. The design of the corresponding profile areas is such that the elastomer body 4 and the annular flange 3 are axially connectable by insertion.

The elastomer body is made of a composition which comprises from 20 to 30% by weight of natural rubber and from 20 to 30% by weight of butadiene rubber, based in each case on the total weight of the composition. The composition can optionally comprise other components, for example fillers, plasticizers, aging inhibitors, crosslinking agents, or the like.

FIG. 2 is a diagram of an elastic drive shaft coupling 1a for absorbing reaction forces from an articulated shaft and vibration damping, in particular for construction-site machinery, tippers, railroad propulsion systems, and boat propulsion systems. The drive shaft coupling 1a is particularly suitable for use in piston engines for direct attachment of an articulated shaft.

The drive shaft coupling 1a is preferably used in the torque range from 480 to 14800 Nm. The drive shaft coupling 1a comprises an elastomer body 4a designed as annular element.

The drive shaft coupling 1a, with its elastomer body 4a, can be attached directly by a screw-thread connection to the flywheel of an engine by way of a flange bearing 2a. The torque is transmitted by way of the elastomer body 4a to a cardan flange 3a. Here, the articulated shaft can be attached to a machine, a transmission system, or the like. Cylindrical bolts 6 are used to connect the cardan flange 3a to the elastomer body 4a. Radial bearings 7 and axial bearings 8 permit rotational movement between the bolted components and the flange bearing 2a.

In order to avoid repetition in relation to description of the materials of the elastomer body 4a, reference is made to the description of the composition for the elastomer body 4 as in FIG. 1.

1. A composition, in particular for an elastomer body of an elastic coupling, comprising the following components:
from 20 to 30% by weight content of polyisoprene rubber,
from 20 to 30% by weight content of butadiene rubber, based in each case on the total weight of the composition.

2. The composition as claimed in claim 1, wherein the polyisoprene rubber is cis-1,4-polyisoprene rubber, preferably natural rubber.

3. The composition as claimed in claim 1, wherein the butadiene rubber is cis-1,4-polybutadiene rubber.

4. The composition as claimed in claim 1, comprising, based on 100% by weight,
from 20 to 30% by weight of natural rubber,
from 20 to 30% by weight of butadiene rubber,
from 35 to 55% by weight of filler,
from 0 to 10% by weight of plasticizer,
<5% by weight of aging inhibitor, and
<5% by weight of crosslinking agent.

5. The use of a composition as claimed in claim 1 for the production of an elastomer body, in particular for an elastic coupling, preferably elastic shaft coupling.

6. An elastomer body, in particular for an elastic coupling, preferably elastic shaft coupling, comprising a composition as claimed in claim 1.

7. A coupling, preferably shaft coupling, comprising a composition as claimed in claim 1.

8. The coupling as claimed in claim 7, wherein the elastomer body has been bonded coherently by means of vulcanization to at least one adjacent coupling component.

9. A coupling, preferably shaft coupling, comprising an elastomer body as claimed in claim 6.
